(19) United States
(12) Patent Application Publication
(10) Pub. No.: US 2012/0216799 A1
(43) Pub. Date: Aug. 30, 2012

(54) Method for Obtaining White Sugar from Cane Juice

(76) Inventor: Mario Alavés Bolanos, Tlalnepantla (MX)

(21) Appl. No.: 13/376,493

(22) PCT Filed: Jan. 11, 2010
(86) PCT No.: PCT/MX2010/000002

§ 371 Date: Dec. 6, 2011

(30) Foreign Application Priority Data
Nov. 19, 2009 (MX) MX/A/2009/012528

(51) Int. Cl. C13B 20/00

(52) U.S. Cl. 127/48

(57) ABSTRACT

The invention relates to a method for obtaining white sugar from cane juice, characterized in that it involves: obtaining sugar colors of between 300 and 150 ICUMSA units, with a sulphite content no greater than 5 ppm and an ash content no greater than 0.2% in the case of white sugar and in the case of refined sugar with colors less than 40 UI, less than 5 ppm sulphites and less than 0.04% ash, using fewer chemical products and devices and comprising the formation of reducing sugars; as well as optimizing the production time, reducing deterioration, making the process and the chemical products more efficient and preventing SO2 contamination. The method is characterized in that it simplifies the traditional method of obtaining white sugar using elemental sulfur, eliminating prealkalinization and sulphiting and the respective machinery and equipment and reducing the number of chemical products, such as lime, phosphoric acid, sulfur and activated carbon, in order to aggregate only sodium metabisulphite optionally complemented with monosodium phosphate in juice with pH values of 4 to 6.6 prior to any process involving the clarification of juice, cane syrup or molten liquor.

### FIELD OF THE INVENTION

Present invention refers to a method for obtaining white or refined sugar from sugarcane juice, characterized by obtaining: 1) sugar colors comprised from 300 to 150 ICUMSA units, with a sulphite amount no higher than 5 ppm, and no more than 0.20% ashes, in the case of white sugar and in the case of refined sugar with colors less than 40 UI, sulphites less than 5 ppm and ashes less than 0.04%, 2) with a lower amount of chemicals, 3) fewer equipment required, 4) less reducing sugar formation, 5) optimization of production time, 6) decreasing equipment damage, 7) efficiency in chemicals and process, and 8) preventing pollution with SO₂ in fields, cities and water bodies.

This method is specifically characterized by:

1. Adding sodium metabisulphite whether or not supplemented with monosodium phosphate to diluted juice or also called mixed juice.

2. Whitewashing juice with chemical lime (Ca(OH₂)) for increasing pH from 5-0-5.5 for treated juice with product in question until 7.0-7.2.

3. Treated juice is heated from 102-104 ° C., in heating equipments using turbine exhaust vapor for steam generation.

4. High-molecular weight, MW 20 to 40 million, polyacrylamide type flocculant is added, with a 30-35% anion charge diluted at 0.1% in juice and reaching a clarification equipment which entraps and decants the sludge formed by precipitated impurities by metabisulphite action whether or not supplemented by monosodium phosphate, lime and phosphoric acid when required, obtaining a bright and translucent juice herein called clear juice.

5. The foam or mud, enters into a filtration process wherein one part is disposed as compressed mud called foam and the other part called filtered juice which is usually returned to an alkali treatment tank.

6. Clarified or clean juice may be returned with this process in order to continue its processing, for obtaining in practice a clean filtered juice, with similar reducers and colors to those from clear juice.

7. Thereafter, it enters into a pre-evaporation and evaporation stage for water removal leaving a 60° to 65° Bx concentrated juice, called clear juice syrup.

Clarification process ends here in some sugar mills then entering into processes for crystallization, centrifugation, washing, drying and packaging or bulk handling. This called standard or sulphited sugar is characterized by having 300 to 240 UI colors (ICUMSA units), sulphites less than 5 ppm and ashes less than 0.2%.

8. Clarification of clear juice syrup is used in some factories in order to remove more pollutants; this stage uses flotation clarification unlike decanting clarification. This consists of adding phosphoric acid from 100 to 200 ppm, alkali treatment with chemical lime at 6.2 to 6.4 pH, heating the clear juice syrup from 82 to 86° C. and adding an anionic-charge high-molecular weight polyacrylamide type flocculant, from 20 to 30% and air in minibubbles through a cavitator starting a clarification process by flotation wherein a low-turbidity low-color clarified clear juice syrup is obtained. When sodium metabisulphite is added to this process in the raw clear juice syrup tank and before applying phosphoric acid, turbidity and color are decreased between 30 and 50% for entering into the next crystallization step.

Clear juice syrup and juice clarification process ends here in some other sugar mills in order to continue with the stages of crystallization, centrifugation or washing and drying for packaging or bulk sale. This sugar is characterized by having a color quality from 250 to 150 UI, sulphites less than 5 ppm and ashes less than 0.2%.

9. A refining or refinery process is used in order to further remove more pollutants, mainly consisting of melting sugar with hot water and passing it through a clarification process by adding phosphoric acid, Alkali treatment at 6.0 to 6.2 pH, heating molten liquor, occasionally adding a polyamine type organic bleaching agent and always a polyacrylamide type, low anionic charge (7% to 10%) flocculant, then clarifying by flotation, adding phosphoric acid, chemical lime and activated carbon, filtered and following with its crystallization, centrifugation, washing and drying process for packaging. When sodium metabisulphite is added into the molten liquor tank in this process before applying phosphoric acid, a color decrease from 20 to 30% is obtained, for obtaining white sugar with colors less than 40 UI, sulphites less than 5 ppm and ashes less than 0.04%.

10. For obtaining standard sugar with colors from 150 to 240 UI, sulphites less than 5 ppm and ashes less than 0.2%.

Sugar color will depend on the amount of sodium metabisulphite added in the process, both into diluted juice and raw clear juice syrup.

An average dose is 100 ppm in diluted juice, juice base and 200 ppm in raw clear juice syrup, base clear juice syrup.

### BACKGROUND OF INVENTION

In a study about sugar in Mexico, conducted by El Colegio de Postgraduados campus Veracruz and Fundacion Produce de Veracruz, A.C., the following is recited: “Equipments with lower efficiency were formerly used by manufacturing industry, characterized by using a remarkable amount of oil, energy, which required a longer number of work shifts for operation. Yield as well as product quality were lower. Productive process in factory caused pollution and obtained yields were lower due to different circumstances: less cane preparation, less efficient soaking, slower clarification, etc., some of the disclosed elements in turn caused higher sucrose losses in honeys, bagasse and foam.

Equipment operation is currently going through a different way than above in some features: equipments are performing with less oil, energy and labor consumption. Yields as well as product quality are higher. Currently used equipments have a good number of elements common with those just previously used, pollution is still a problem even when some elements to overcome it are noticed.

“Principles in sugar production have not been modified along time, being essentially the same: sugarcane juice extraction, clarification (Strainers, Sulphiting, Neutralization, Heater, Clarificator, Foam Filters), evaporation and crystallization. However, the equipment where these processes are carried out has evolved (new materials, automation and control), thus reaching a higher efficacy and promptness in sugar industry, directly and beneficially impacting final product quality.

Film evaporators, “raw” ultrafiltration system refineries and installation of ionic exchange columns and generally thermal-energetic arrangements are remarkable innovations to be introduced into sugar cane factories.

The following is also mentioned “For transformation industrial process optimization, the introduction of “CLEANER PRODUCTION TECHNIQUES” including reissuing material and energy balances for thermal-energetic and water self-sufficiency achievement is required; dramatic reduction of waste impact to environment (water and energy) and polluted area bioremediation (soil and receptive ponds).

The following is advisable in order to contribute to factory cost reduction once fundamental balances are modified: reduction in number of operation units (less equipments with higher individual capacity), thus development and maintenance expenses are reduced; promoting continuity in batch operations (sugar-pans and centrifuges) and preventing low purity material recycling (C-strikes suppressed).

And finally it is said that “In order to ameliorate destruction of equipment and devices subject to friction and abrasive/corrosive wear, applied research should be targeted towards the use of thermoplastic materials as well as the use of stainless steels and teflon (it is worth to remind that this is a food producing industry).”White sugar obtained by described methods has a quality of: 220 to 300 UI colors, 8 to 10 ppm sulphites, 0.2 to 0.4% ashes.

Patents for cane juice clarification using sulfurous acid base are available as references, but always starting from SO₂ formed by sulfur burning. These patents are CN1206082, CN1068145, CN1121113, U.S. Pat. No. 4,076,552, and CU33740.

### OBJECT OF INVENTION

The invention refers to white sugar production characterized by having:

1) sugar colors comprising 300 to 150 ICUMSA units, with a sulphite amount not higher than 5 ppm, and no more than 0.20% ashes for white sugar and in case of refined sugar, colors less than 40 UI, sulphites less than 5 ppm and ashes less than 0.04%.

2) decreasing the amount of chemicals in process,

3) decreasing the number of equipment and machinery in process,

4) preventing reducing sugar formation due to bacteria or pH differences in process,

5) optimizing factory time,

6) decreasing equipment wear.

7) Efficiency in chemicals and process.

8) preventing SO₂ pollution in field, cities and water bodies.

Indeed, this invention achieves white and refined sugar production with above mentioned features with the following advantages:

1) Improvement in sugar quality; a) in color due to sodium metabisulphite bleaching, clarifying and bactericide reaction efficiency, b) in sulphite content, by reacting 100% metabisulphite with juice, c) in ashes by decreasing lime in 30%, formation of calcium sulphite with juice calcium and other pollutants removed in clarification.

2) Preventing the use of:

a) organic bleaching agents, such as polyamines and polidagmas, b) modified tannins, c) natural zeolites, d) a sulphiting system with elemental sulfur burning very pollutant for environment, e) SO₂ donors, such as sodium sulphite, sodium bisulfate, sodium hydrosulphite, f) enzymes or peroxides and other substances for lowering sugar color g) decreasing the amount of lime and phosphoric acid added into the diluted juice for obtaining white sugar and decreasing the organic bleaching agent and activated carbon in refined sugar production.

3) Preventing use, time and maintenance of equipments such as

a) prealkalinization equipments, b) furnaces, sublimation chambers and sulphiting towers and c) filtered juice clarifiers.

4) Antibacterial metabisulphite action applied in this process stage: a) prevents juice damage along process. b) sugar loss is minimized as a pH difference is not present between diluted and purified juice with metabisulphite whether or not supplemented with monosodium phosphate.

5) A.—Optimizing factory time a) upon removal of prealkalinization, sulphiting system in conventional process with sulfur burning and filtered juice clarification, saving retention time and reprocessing filtered juice.

B.—Decreasing equipment wear and inner damage: a) said product decreases machinery corrosive conditions, by having a pH equivalent to diluted juice, that is, higher than sulphited with sulfur burning b) substances which form process plugs affecting factory time are not produced, c) substances which cause fouling affecting heat and energy efficiency in evaporators are decreased and sugar is not contaminated by machinery degradation (soluble Fe), causing a color increase when in storage, reducing sulphite and ash amount in sugar.

6) Unlike conventional sulfur burning process, this process does not cause SO₂ environmental emissions.

Technical Problem Discussion

1) The trends in sugar cane mechanical harvesting worldwide industry oblige to find new factory processes to fight dirtiness, soil, and bacterial pollution developed in each cut, which make sugar production difficult for market demanded quality, in addition to a world demand of new cleaner production practices.

2) The amount of chemicals used in factory are susceptible elements for sugar and environment pollution and degradation as well as factory cost rise impacting profit directly, in the case of: A) elemental sulfur, B)calcium hydroxide, C)Phosphoric acid D) polyamine and polidagmas type organic bleaching agents E)activated carbon and F) High molecular weight polyacrylamide type flocculants are indispensable elements for obtaining a better color and quality sugar in its different clarification processes, whether juice, clear juice syrup or molten liquor for refinery, a decrease thereof would significantly help in cost-quality objectives without affecting environment or product.

A) Sulfur itself seems to have a relatively low cost in marketplace although it represents one of the highest costs in process wherein between 100 to 300 ppm juice-base are normally used in the whole process, thus incurring in expenses of: a)special product, transportation and storage, b) government or army controls, restrictions or permits because of an explosive parent element, c) environmental costs due to gas emissions into atmosphere by degrading fields and water bodies; the way of adding it into juice is by vacuum, whether by sulphiting tower or ejector equipment, and SO₂ bubble carried into the juice is of large size and only remaining a small SO₂ portion (less than 30% of formed SO₂), the other 70% goes into atmosphere as SO₂, which upon combining with air moisture becomes sulfuric acid; d) corrective, preventive and repair maintenance costs in sulphiting system as well as a degradation inside and outside the factory due to sulfuric acid corrosive capacity generated by sulfur, in addition to the sugar quality affected by these problems; e) as sulfur burning is not adjusted to juice flow changes, obtained sugar quality has quite pronounced peaks in color affecting composed sugar color and affecting quality thereof; f) Furnace cannot be turned off when any shutdown occurs at sugar mill since it requires from 4 to 5 hours to be turned on, thus wasting and polluting along this time. g) Opportunity cost due to reducing sugars leading to undetermined losses by a pH differential, whether searching quality by increasing the amount of sulfur or by single flow movements in process without being able to control sulfur amount, formed SO₂ in this way upon contacting the diluted juice decreases juice pH which is normally between 5.0 to 5.5, down to values between 4.0 to 4.5, this favoring sucrose inversion and forming reducing sugars. h) A SO₂ overdose to diluted juice causes severe fouling in evaporators and corrosion due to sulfurous acid formation and SO2 production generating energy waste and severe and continuous cleaning in evaporators. i) Opportunity costs in marketplace by not meeting environmental issues requested by clients or by international standards such as ISO 14000 and others, and j) a latent work risk by elemental sulfur burning.

B) Lime, the use of lime is one of the more sensitive factors for a) generating pollutant residues in sugar, b) generating fouling in evaporators and thus a decrease in lime use in process would be highly desirable.

C) Phosphoric acid, being a juice complement for conducting the chemical reaction together with lime, heating, and flocculant, this being determined by phosphate level already comprised in sugar cane, a decrease thereof contributes to cost reduction of chemicals used in factory.

D) Organic bleaching agent applied in refinery as a coadjuvant for color decrease, its decrease contributes to a better cost.

E) Activated carbon, its decrease contributes to reduced costs in chemicals high cost.

F) Polyacrylamide type flocculants. A good preparation, application and dose control of flocculant helps to manufacturing cost reduction as well.

3) Alternatives for decreasing maintenance, operation, repair, space and retention time expenses are indispensable as any process equipment represents a specific cost.

4) Degradation time in juice represents the most sensitive element in sugar production since as time elapses in juice there is a higher number of reducing sugars for bacteria reproduction decreasing factory yield, reducing sugars have a damaging effect in strike viscosity increasing it up to such level that a wrong crystal formation is caused as well as difficulty for handling magma. Reducing sugars are combined with aminated compounds and lead to color formation in final sugar.

5) Consequently the time invested in each process in sugar production should be quite efficient for maximizing sucrose production, this involving a good chemicals performance supporting the process for improving efficiency where deficiencies are met in bactericides and sulfur burning upon not controlling the total reducing sugar increase by bacteria, and in the case of sulfur only about 30% of SO₂ production remains in juice when sulfur is burned and the remaining being sent into atmosphere, combined with air moisture and forming sulfuric acid, making that SO2 and sulfuric acid mixture lowers its pH values down to 4.0 to 4.5 upon contact with diluted juice which favors sucrose inversions in diluted juice towards glucose and fructose, the so-called reducing sugars. Sucrose losses by inversions from 0.2 to 0.4% are present in this part of the process.

6) Preventing factory deterioration: As machinery is one of the most important assets, the in-use time should be kept as long as possible in order to achieve company's financial goals thus requiring preventing corrosive products which damage inside and outside our equipments; pH values less than 4.5 are susceptible to iron corrosion towards iron salts which wear equipment, and SO2 which is expelled outside to atmosphere combined with air moisture becomes into sulfuric acid, highly corrosive to sugar mill equipment and structure.

7) and since process depends on juice heat action on different stages, we need that products in use are not agents which foul pipes nor evaporators as retention time and efficiency for juice dehydration and transformation into clear juice syrup is a sensitive point, as it happens in case of sulfur burning, an overdose of SO2 above its saturation point acts over calcium sulphite precipitate (CaSO3) formed in sulphiting and serving for colloid removal, being dissolved in diluted juice and forming calcium hydrogen sulphite CaH(SO3) which upon entering into evaporators forms corrosion-causing sulfurous acid and sulphite salts which cause severe fouling in piping.

8) Finally as in any transformation process, productivity and ecology should go together to prevent a vicious cycle in degrading field, water, air to provide more environmentally friendly systems which prevent this wear.

Atmospheric pollution by SO2,

When using sulfur burning for sulphiting, forming SO2 to temperatures of 200° C., only a small amount of SO2 formed in sulfur furnace is introduced into the diluted juice; this is not easy to quantify but we estimate that only between 25 to 40% remains in juice by any method used in sugar mill, all of them operating to vacuum. Remaining 60 to 75% SO₂ goes into atmosphere, forming sulfuric acid and acid rain with air moisture.

By using liquid sodium metabisulphite upon contact and at the same temperature, product supply between 60 to 65% of SO₂ remains 100% in juice without any pollution to environment.

As an example seeming important, average SO₂ required in a sugar mill for obtaining sulphited white sugar is 300 ppm (grams of SO₂ per milled sugar cane ton, as SO₂). One sugar mill grinds 10,000 tons of sugar cane per day, demanding 3,000 kilograms per day of SO₂. 2,100 daily kilograms are sent into atmosphere. More than 55 million sugar cane tons are milled only in Mexico along the 6-month sugar cane crop, representing 16,500 required tons of SO₂ and pollution by 11,550 tons of SO₂ between December and June.

### Technical Problem Solution

In order to solve the white and refined sugar process technical problem and to achieve:

1) sugar colors comprising from 300 to 150 ICUMSA units, with a sulphite amount not higher than 5 ppm, and no more than 0.20% ashes,

2) with a lower amount of chemicals,

3) Fewer equipment required,

4) Less reducing sugar formation,

5) Optimizing factory time.

6) Decreasing equipment damage.

7) Efficiency in chemicals and process.

8) preventing pollution of field, cities and water bodies with SO₂.

The method described below is used as a solution to above cited points:

### Juice Clarification

1) A new juice purification and disinfection process is used applying food grade sodium metabisulphite, with low heavy metal content, whether or not supplemented with monosodium phosphate, being added to sugarcane juice after leaving mills, having passed through a soaking and filtration process, having removed the prealkalinization process and uniformly mixing in the diluted or mixed juice with a minimum retention time of 10 minutes before entering into the liming process, this purification and disinfection process characterized by:

A. The use of sodium metabisulphite whether or not supplemented with monosodium phosphate at diluted juice conditions, with temperatures from 30 to 40° C., pH from 5.0 to 5.5, solids from 14° to 16° Bx and sucrose from 12 to 16% and contact times from 10 to 15 minutes before adding lime, in order to:

a) release SO₂ for juice bleaching. Method of use of sodium metabisulphite in this process stage prevents color formation in juice since SO₂ contained in sodium metabisulphite formula reacts with some juice components for blocking some colorant reactions (Maillar reaction) and prevents reducing sugar formation which supplies color to juice.

b) use it as bactericide from the first stage of diluted juice for preventing reducing sugar or juice degradation, also acting as bactericide in addition to bleaching and purifying the diluted juice, aiding in microbiological control where “leucanostoc mesenteroides” bacterium decomposes sucrose in reducing sugars (glucose and fructose), which do not crystallize and remain in sugar accounts as undetermined losses.

c) Precipitate colloids not performed by sulphiting with sulfur burning or other SO₂ sources. Color and turbidity removal will depend on precipitates generated by reacting sodium metabisulphite, whether or not supplemented with monosodium phosphate, with juice impurities, lime and temperature. Purified and disinfected juice components with said process, first with added phosphates to juice as external sources such as phosphoric acid or others including monosodium phosphate (complement of this product), or phosphates from the juice itself which are at levels higher than 150-200 ppm will produce tricalcium phosphate which with aid from high molecular weight polyacrylamide type flocculant will entrap some color donor colloids and turbidity in juice and on the other hand 35% of sodium metabisulphite formula will react with juice calcium, lime and temperature forming calcium sulphite, another precipitate which will entrap other colloids that with aid by flocculant remove other juice components which provide color and turbidity.

B. Application dose varies from 50 to 200 ppm (grams of product per cubic meter of diluted juice (1000 liters diluted juice), according to desired clear juice quality. In order to determine the most suitable dose, a clarification test is performed in laboratory as explained below.

C. Reducing the amount of applied lime in liming process in 20-30% respect to the conventional process, thus applying only the suitable amount to rise purified juice pH (5.0-5.5) and disinfected with sodium metabisulphite whether or not supplemented with monosodium phosphate at 7.0-7.4 then called limed juice, representing a lower amount of impurities and calcium added to diluted juice. This leads to lower fouling in juice heating equipment and evaporators.

D. The most significant action is that comparatively with sulphiting process with sulfur where diluted juice has pH decreases from 4.0 to 4.5 and sucrose inversion into glucose and fructose (reducing sugars) is present, upon adding sodium metabisulphite diluted juice pH remains in an initial pH of 5.0-5.5 and sucrose inversion is reduced, in other words, less reducing sugars are formed. This results in a higher sugar recovery (yield increased from 0.2 to 0.4%) and a further process with less viscosity increase in masses, better forming the sugar grain in sugar pans and fluidly discharging to centrifuges, where wash time may be decreased in 25%. Therefore the quality of this product may be improved to obtain better colors without altering juice pH, preventing reducing sugar formation by pH variation.

E. Heating from 102 to 104° C. in juice heaters and removing gases in a so-called “flash” tank.

F. Passing through a decanting clarification equipment supported with a high molecular weight and 30 to 35% anionic charge flocculant, with doses from 5 to 7 ppm (grams per m3 of diluted juice).

G. A clear juice is obtained with UI color reduction (Icumsa units) of at least 20% depending on juice impurities and the amount of added sodium metabisulphite whether or not supplemented with monosodium phosphate, observing removal from 40% to 60% in transmittance, and a turbidity reduction from 40% to 50%, compared with those obtained with sulfur sulphiting.

### Clear Juice Syrup Clarification

2. Clear juice syrup is clarified in some sugar mills in order to reach a better sugar quality, achieving colors of 150 UI or lower. By applying sodium metabisulphite at a rate from 100 to 400 ppm (grams of product per m3 of clear juice syrup) a color decrease is obtained in the range from 1800 to 2500 UI and from 60 to 70% turbidity compared with the conventional clarification process without sodium metabisulphite obtaining colors in the range from 8,000 to 9,000 UI, and turbidity less than 70 NTU in clarified clear juice syrup, where sugar colors less than 150 UI and sulphites (SO2) less than 4 ppm may be obtained.

A laboratory test is made as detailed below for dose determination.

### Clarification in Refinery

3. The refining or refinery process is used in order to remove even more pollutants, mainly consisting of melting sugar with hot water and passing it through a clarification process adding phosphoric acid, liming at pH between 6.0 to 6.2, heating the molten liquor, adding occasionally an organic bleaching agent and always a low anionic charge flocculant, clarifying by flotation, adding activated carbon, filtering and following with its crystallization, centrifugation, washing and drying process for packaging or bulk sale. When sodium metabisulphite is added in this process just before applying phosphoric acid, a color decrease from 20 to 30% is obtained for producing white sugar with colors less than 40 UI, sulphites less than 5 ppm and ashes less than 0.04%.

### DETAILED DESCRIPTION OF INVENTION

### Clarified Juice

The invention refers to the addition of food grade water-diluted sodium metabisulphite whether or not supplemented with monosodium phosphate to sugar cane diluted juice, with mechanical stirring at a 50% weight concentration and adding to mill output diluted juice and preparing the solution every 4 hours.

Solution sodium metabisulphite dosage is suggested to be automated by coupling the diluted juice rotameter with a frequency variator in metering pump.

Application is made after juice filtration through rotary or stationary type filters, for bagasse removal. Free phosphates are determined in primary juice, which shall be in the range from 250 to 300 ppm assisting in juice purification. Contents less than 200 ppm of free phosphates should be supplied with phosphoric acid or monosodium phosphate in the range of 50 to 100 ppm ground sugar cane base. Phosphoric acid or monosodium phosphate shall be added in diluted juice forming tricalcium phosphate with calcium carried in sugar cane juice.

Sodium metabisulphite in solution upon entering in contact with diluted juice, at a temperature (30 to 50° C.) and pH (5.0 to 5.5), releases from 60 to 65% SO₂ and the remaining forms a calcium sulphite precipitate CaSO3, acting as a clarification means removing colloids.

pH of diluted juice in this point does not change when sodium metabisulphite is added, as with sulfur burning sulphiting which lowers values from 4.0 to 4.5.

SO2 formed in this way is advantageously used up to 100% by forming to the same temperature than juice and at atmospheric pressures.

Sodium metabisulphite retention time before liming shall be from 10 to 15 minutes. Sodium metabisulphite is sensitive to juice pH or acidity, the lower pH the faster SO₂ is released.

Prealkalinization shall be removed from sugar mills when using sodium metabisulphite as the former is not necessary and may cause lack of control in lime addition by not changing pH from diluted juice to treated juice with sodium metabisulphite.

DOSES. Doses vary from 50 to 250 ppm sodium metabisulphite per cubic meter of diluted juice.

The so-called clarification or jar laboratory tests are performed for dose determination.

### Clarification Tests

For determining sodium metabisulphite initial doses in diluted juice, clarification tests are performed in laboratory, starting from the basis that sulfur amount in ppm applied to juice, one half of sodium metabisulphite is calculated, that is, a sugar mill using 200 ppm of sulfur in a juice cubic meter base, 100 ppm of sodium metabisulphite shall be used as follows.

a. Sampling mixed, filtered juice without any treatment with chemicals.

b. Sampling 500 ml in a vessel to be boiled.

c. Adding 100 ppm of sodium metabisulphite, equivalent to 50 mg.

d. When phosphoric acid is used, add it in the same amount as in process.

e. Sodium metabisulphite is well-dissolved in juice, mixing for 10 minutes.

f. Lime is added to increase pH to 7.0-7.2.

g. Heat is provided until boiling.

h. Heated juice is passed to each of the metering cylinders.

i. Different flocculants at 5 ppm are added, in order to determine the best performance in clarification.

j. The prototype for process dose is taken from that having the best displacement of formed precipitate and showing a clear and bright juice.

k. Clarified juice is sampled and Bx, sucrose and purity; icumsa color, % transmittance, turbidity and reducing sugars are determined. This result is compared with data obtained from process clarified juice at the same time than sampling, thus being noticed the advantages of this sulphiting process with sodium metabisulphite, compared with that used by burning sulfur. Obtained results in laboratory test are demonstrated to be reproducible in process.

### Field Application

1) After obtaining a sodium metabisulphite dose in laboratory to be applied on mixed juice, the amount of kilograms of product per hour is calculated. A dose of 100 ppm ground sugar cane base for a sugar mill processing 10,000 daily tons of sugar cane for instance, will have a dose of 1000 kilograms per day and for 24 hr, 41.66 kg per hour.

2) A 50% weight product solution shall be prepared to be applied every 4 hours. With above example 166.64 kilograms every 4 hours, dissolved in 170 liters of water should be added. This solution has a density of 1.3 gr/cm³, then 170+166.64/1.3=260 liters every 4 hours. 65 liters per hour shall be applied of a sodium metabisulphite solution, with a pH from 4.0 to 4.5 and density of 1.3 gr/cm³.

3) Application point shall be in the already filtered mixed juice tank with rotary filter or stationary filter, which remove bagasse.

Clarified Juice with Sodium Metabisulphite is Characterized by:

A. It contains less impurities, purity higher than 1 to 1.5 points, less turbidity from 40 to 50%, better transmittance from 60 to 70%, better color from 20 to 25%, compared with that obtained by elemental sulfur burning process.

B. Juice with less reducing sugars from 25 to 30%.

White sugar obtained with sodium metabisulphite is characterized by having less color from 20 to 30%, a more smooth grain, lower sulphite content (less than 5 ppm, as SO2).

Standard sugar under Mexican standards has a maximum 20 ppm limit of sulphites (SO₂), ashes less than 0.25%.

### Clarified Clear Mice Syrup.

### Application of MBS, Sodium Metabisulphite to Clear Mice Syrup.

In addition to applying sodium metabisulphite to diluted juice, raw clear juice syrup is added at a rate from 200 to 400 ppm, grams of MBS per m3 of clear juice syrup, in order to obtain colors less than 150 UI.

Clear juice syrup is approximately equivalent to 25% of diluted juice, due to water lost in evaporation and equivalent to 50 ppm of MBS grams per m3 of diluted juice.

### Clarification of Clear Juice Syrup

For clear juice syrup clarification and production of better quality sugars, equipments were designed with the addition of phosphoric acid and lime, supplemented with air addition in mini-bubble form to have rapidly formed muds floating. Process principle consists of forming a tricalcium phosphate precipitate entrapping colloids and suspended solids in clear juice syrup. A medium anionic charge (20 to 30%) and medium to high molecular weight polyacrylamide type flocculant is added to make flotation more efficient.

Clarifier equipment also called “floater”, forms a mud cake in upper section, and clear juice syrup is generated below that with less turbidity and color, ensuring a better quality of obtained sugar.

The use of sodium metabisulphite at a dosage from 200 to 400 ppm clear juice syrup base (grams of MBS per ton of clear juice syrup), has a clarification and bleaching effect which remarkably improves the clarified clear juice syrup, reducing turbidity and color in more than 20%, compared with that obtained only with phosphoric acid, lime and flocculant.

Laboratory tests are used as explained in detail in page 29 in order to determine the most suitable dose.

### Application of MBS to Clear Juice Syrup Clarification Process.

After obtaining an initial dose from laboratory tests, the amount of MBS to be applied to the process is calculated in the following way:

Assume an example where a sugar mill grinds 10,000 sugar cane metric tons per day and initial dose in laboratory tests was 200 ppm (mg of MBS per liter of clear juice syrup), 16° Bx mixed juice and 65° Bx clear juice syrup.

Dose is calculated in the following way in kg/hour.

10,000 mt of ground sugar cane×16/65=2,461.53 tons of clear juice syrup/day.

200 ppm MBS=200 g MBS/ton of clear juice syrup
200 (g/ton)×2,461.53 (ton per day)=492.30 kg/day MBS.

### MBS Preparation and Application

Preparation of a 50% solution with water.

Preparation of said solution every 4 hours.

Concentration amount to be added for a 50% weight water solution is:

492.30 kg/day/24 hours=20.5 kg/hr×4 hours=82.05 kgs/4 h. 82.05 kg/hr MBS+82.05 water=164.1 kg/4 hours

Solution density at 50%=1.3 kg/liter.

164.1 (kg/4 h)/1.3 kg/lt=126.23 liters/hour.=31.55 liters/hour (LPH).

### Application Point

Application point shall be at clear juice syrup tank leaving evaporators and before phosphoric acid addition and/or in the same point.

Indicators:

The following obtained laboratory data for raw and clarified sugar shall be registered and plotted: turbidity, color, reducers every hour, in order to compare them with those obtained without using sodium metabisulphite.

Obtained clear juice syrup with the use of sodium metabisulphite is characterized by having: less color and turbidity.

Clarified Clear Juice Syrup and Obtained Sugar with Sodium Metabisulphite is Characterized by:

A. A decrease in color from 1800 to 2500 UI.

B. A decrease in turbidity from 40 to 60%.

C. Sugar with colors less than 180 UI, sulphites less than 4 ppm and ashes less than 0.2%.

### Application of Sodium Metabisulphite in Sugar Refineries.

For obtaining refined sugar in colors less than 25 UI, sodium metabisulphite is used in raw or standard sugar molten stock, decreasing color which favors obtained sugar quality and decreasing addition of activated carbon.

Dose for this sugar process part is from 50 to 100 ppm molten sugar base.

Application point is provided in molten sugar tank, this molten sugar (molten liquor) follows its refining process as follows:

1. Phosphoric acid between 100 to 200 ppm, molten liquor base, is added. In this point bleaching chemicals such as polyamines, polidagamas, aluminum polychlorides and mixtures thereof are used, having the effect of precipitating undesirable colloids at a rate between 80 to 120 ppm molten liquor base.

2. Lime is added to keep a pH from 6.2 to 6.4.

3. A low anionic charge polyacrylamide type flocculant is added and heated, with a 10 to 12 ppm molten liquor base dose.

4. Passage to a flotation clarification equipment, supported with mini-bubble addition for fast mud separation in upper section.

5. A clear liquor is obtained adding activated carbon thereto and passing through filters with aid of products called “filter aid”, where remaining residual color is removed.

Refined Sugar Obtained with Sodium Metabisulphite Addition is Characterized by:

1. better color, without altering the sulphite content.

2. decrease of chemicals, organic bleaching agents and activated carbon.

### Application to Sugar Refinery.

Following with a sugar mill example grinding 10,000 metric tons of sugar cane per day, 10% yield and a 50 ppm base molten liquor dose, sodium metabisulphite is to be added as follows:

Produced sugar: 1,000 tons per day.

MBS dose: 100 grams per ton of molten liquor.

Molten liquor (at 60° Bx): 1,000 ton sugar/0.60=1,666.66 ton of molten liquor.

50 g MBS×1,666.66=83.33 kg/day.

Every 4 hours=83.33 (kg/day)/24 (hours)×4 hrs.=13.88 kg/4 hr.

50% solution: 13.88 kg MBS+13.88 water=27.76 kg of a 50% MBS solution, to be added every 4 hours.

Density=1.3 kg/lt.

27.76 kgs./1.3 kg/lt=21.35 liters/4 hours=5.33 lt./hr.

Application with metering pump; 5.33 liter per hour, from a 50% MBS solution to molten liquor.

1. A process for obtaining white and refined sugar, characterized in that comprises the following steps:
i) Clarification of sugarcane juice by adding a food-grade sodium metabisulphite aqueous solution supplemented at 50% weight at a rate between 50 and 250 ppm of sodium metabisulphite per each cubic meter of diluted juice,
ii) adding Ca(OH₂) to obtained product in prior step until reaching a pH between 7.0-7.2,
iii) heating the juice product of previous step at 102-104° C.,
iv) adding high molecular weight polyacrylamide with a molecular weight between 20 and 40 million with a 30-35% anion charge diluted at 0.1% in juice,
v) clarifying by decantation,
vi) pre-evaporating and evaporating the clarified juice produced in previous step until obtaining a concentrated juice from 60° to 65° Bx,
vii) adding sodium metabisulphite to obtained product from prior step at the same concentration than step in item i),
viii) adding phosphoric acid from 100 to 200 ppm,
ix) adding Ca(OH₂) until reaching a pH between 6.2 and 6.4,
x) heating from 82 to 86° C., and
xi) adding high molecular weight between 20 and 40 million with anionic charge from 20 to 30% and air in minibubbles through a cavitator.
